(19) United States
(12) Patent Application Publication
(10) Pub. No.: US 2022/0186947 A1
(43) Pub. Date: Jun. 16, 2022

(54) PHASE CHANGE MATERIAL AND APPLICATIONS

(71) Applicants: Embry-Riddle Aeronautical University, Inc., Daytona Beach, FL (US); UT-Battelle, LLC, Oak Ridge, TN (US)

(72) Inventors: Sandra Kathleen Sparr Boetcher, New Smyrna Beach, FL (US); Kashif Nawas, Oak Ridge, TN (US); Melissa Ann Messenger, Yulee, FL (US); Casey Josh Troxler, Edgewater, MD (US); Thomas Benjamin Freeman, Carthage, NC (US); Rafael M. Rodriguez, Ormond Beach, FL (US)

(21) Appl. No.: 17/551,524

(22) Filed: Dec. 15, 2021

Related U.S. Application Data
(60) Provisional application No. 63/125,613, filed on Dec. 15, 2020.

(51) Int. Cl. F24F 5/00; F28D 20/02; F24F 13/30

(52) U.S. Cl. CPC F24F 5/0021; F28D 20/023; F24F 2110/10; F24F 2005/0032; F24F 13/30

(57) ABSTRACT

A thermal energy storage heat exchanger can include a core defining a plurality of airflow passages to receive an airstream therethrough. The core can be made of a composite of a phase change material shape-stabilized by a polymer. The phase change material can be structurally supported by the polymer and the phase change material can be configured to change phases to store energy from and deliver stored energy to the airstream when the airflow passes through the core.

### CLAIM OF PRIORITY

This patent application claims the benefit of priority, under 35 U.S.C. Section 119(e), to Boetcher et. al., U.S. Patent Application Ser. No. 62/156,613, entitled “PHASE CHANGE MATERIAL AND APPLICATIONS,” filed on De. 15, 2020 (Attorney Docket No. 4568.010PRV), which is hereby incorporated by reference herein in its entirety.

### STATEMENT REGARDING FEDERALLY SPONSORED RESEARCH OR DEVELOPMENT

This invention was made with government support under award number EcoCAR 3 awarded by The National Science Foundation under the Department of Energy Advanced Vehicle Technologies Competition under grant no. DGE-2041850. Support from the NSF is also acknowledged under grant no. MRI-1337742. The government has certain rights in this invention.

### BACKGROUND

Phase change materials (PCMs) are materials that can change phases, such as between a liquid and a solid, and are able to store or expend latent heat in the process. PCMs such as hydrocarbons can be useful for energy storage for heating or cooling applications, such as in heating ventilation and air conditioning (HVAC). For example, PCMs are often positioned in containment devices to interact with a heat exchange medium (such as water, air, or refrigerant) when the medium flows through the containment device.

### BRIEF DESCRIPTION OF THE DRAWINGS

The patent or application file CONTAINS AT LEAST ONE DRAWING EXECUTED IN COLOR. Copies of this patent or patent application publication with color drawing(s) will be provided by the Office upon request and payment of the necessary fee.

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates a schematic view of a system.

FIG. 2 illustrates a schematic view of a manufacturing process.

FIG. 3 illustrates a step of a manufacturing process.

FIG. 4 illustrates a product of a manufacturing process.

FIG. 5 illustrates a product of a manufacturing process.

FIG. 6 illustrates a product of a manufacturing process.

FIG. 7 illustrates a product of a manufacturing process.

FIG. 8 illustrates a product of a manufacturing process.

FIG. 9 illustrates a product of a manufacturing process.

FIGS. 10A-10C illustrate a heat exchanger and cartridge.

FIG. 11A illustrates a perspective view of a portion of a heat exchanger.

FIG. 11B illustrates a graph.

FIG. 12A illustrates a perspective view of a filament.

FIG. 12B illustrates a perspective view of a filament.

FIG. 13A illustrates a graph.

FIG. 13B illustrates a graph.

FIG. 14 illustrates a schematic view of a portion of a manufacturing system.

FIG. 15 illustrates a schematic view of a portion of a manufacturing system.

FIG. 16 illustrates a portion of a heat exchanger.

FIG. 17 illustrates a portion of a manufacturing system.

FIGS. 18A-18D illustrate perspective views of a portion of a manufactured item.

FIG. 19 illustrates a graph.

FIG. 20 illustrates a perspective view of a portion of a manufactured item.

FIG. 21 illustrates a graph.

FIG. 22 illustrates a graph.

FIG. 23A illustrates an enlarged perspective view of a portion of a manufactured item.

FIG. 23B illustrates an enlarged perspective view of a portion of a manufactured item.

FIGS. 24A-24D illustrate enlarged perspective views of a portion of a manufactured item.

FIG. 25 illustrates a schematic view of a system.

FIG. 26 illustrates a schematic view of a system.

FIG. 27 illustrates a schematic view of a system.

FIG. 28 illustrates a schematic view of a system.

### DETAILED DESCRIPTION

PCMs are useful for exchanging energy or heat and have been used in many heat exchanger and energy storage applications. For examples, PCMs can be used to store energy during off-peak electrical times for use in comfort cooling. PCMs can also be used within heat exchanger for HVAC or battery cooling. However, most PCM heat exchangers require an outer container that supports PCM within the outer container where the container can be expensive and the heat exchanger can have a relatively low thermal efficiency.

The inventors have recognized that a composite of PCM and a polymer (such as HDPE) can be created and can be formed into filaments of a shape-stabilized PCM to be used in fused filament fabrication of a heat exchanger where the heat exchanger composite can be made of 30 to 60 percent (or more) PCM by mass, which can help to provide higher energy storage in a heat exchanger. Further, the composite can be formed into a variety of heat exchanger shapes, such as with different thicknesses, which can help to increase thermal performance of the heat exchanger.

The above discussion is intended to provide an overview of subject matter of the present patent application. It is not intended to provide an exclusive or exhaustive explanation of the invention. The description below is included to provide further information about the present patent application.

APPENDIX A illustrates, generally, various examples such as an approach for manufacturing and forming a heat exchanger using phase change materials.

APPENDIX B illustrates, generally, various examples such as an approach for manufacturing and forming a heat exchanger using phase change materials.

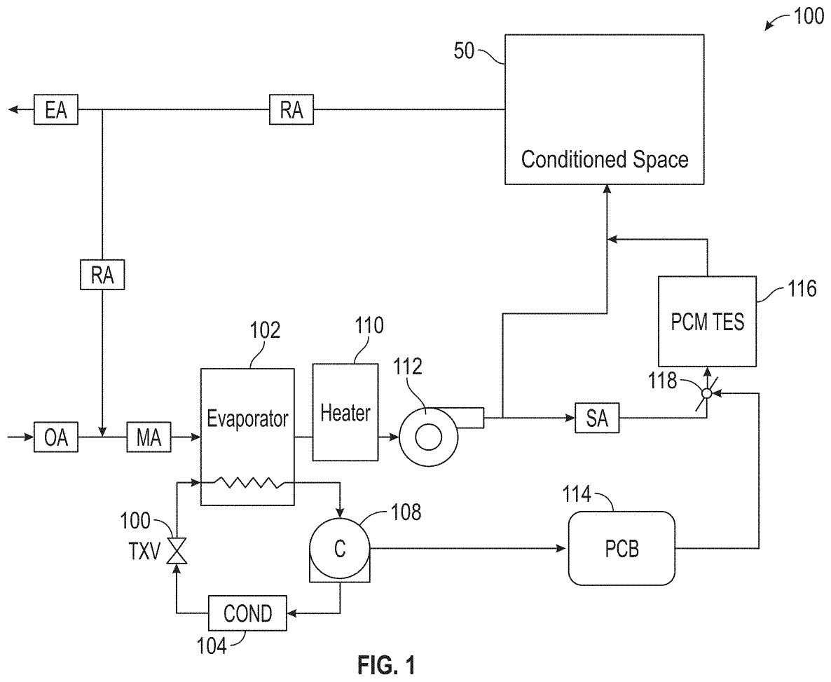

FIG. 1 illustrates a schematic view of a system 100. The system 100 can include an evaporator 102, a condenser 104, a thermal expansion device (or valve) 106, a compressor 108 (e.g., a variable speed compressor), a heater (e.g., a gas-fired heater, a supply fan 112, a controller (PCB) 114, and a phase change material thermal energy storage (PCM TES) 116. FIG. 1 also shows a condition space 50, return air (RA), supply air (SA), exhaust air (EA), mixed air (MA), and outside air (OA).

The system 100 can operate in cooling mode using the evaporator 102, condenser, 104, TXV 106, and compressor 108, which can be operated as a cooling refrigeration system to deliver cooled supply air. The cooled supply air can be selectively delivered to the PCM TES 116 by a control valve 118, which can be an air control valve (e.g., control damper). The controller 114 can determine when it is economic to deliver the supply air to the PCM TES 116 to store energy for later use. For example, the controller 114 can use cost modeling of electricity and can optionally use ambient temperature, supply air temperature, or the like, to determine when to open and close the valve 118 to store energy from the supply air for cooling the supply air at a later time (such as when electricity costs are higher).

Similarly, during heating mode, the heater 110 can be operated to heat the supply air and the energy can be selectively stored in the PCM TES 116 by operating the valve 118 via the controller 114. The PCM TES 116 can be formed of a composite of PCM and a thermoplastic (e.g., HDPE, as discussed in further detail below). The PCM can be selected to have a phase change temperature suitable for storing energy for cooling and heating. Optionally, the PCM TES can include multiple phase change materials, where one PCM is has a phase change temperature optimized for cooling (e.g., 35-65° F.) and a second PCM optimized for heating (e.g., 85-125° F.).

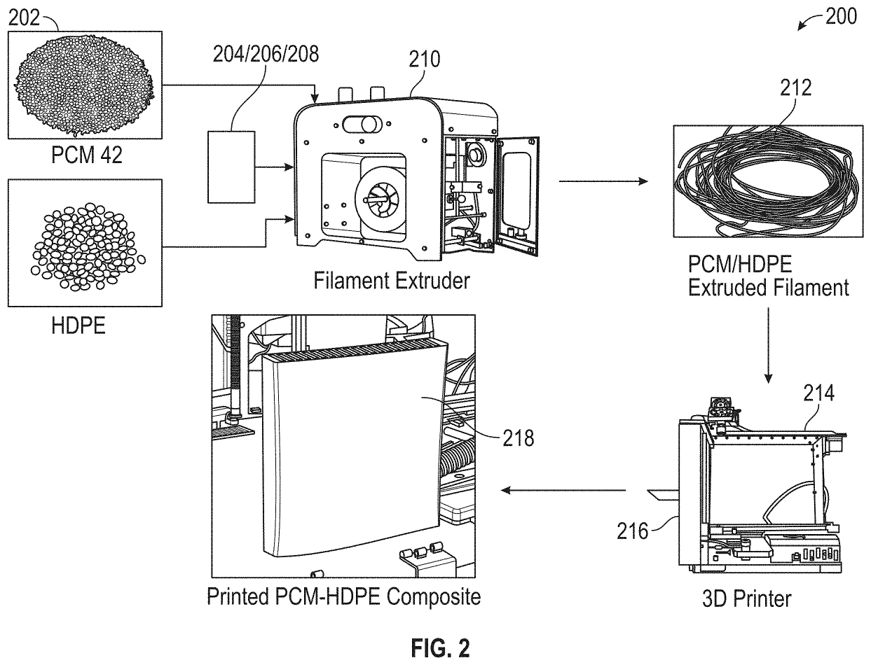

FIG. 2 illustrates a schematic view of the method 200, in accordance with at least one example of this disclosure. The method 200 can be a method of manufacturing a composite PCM heat exchange More specific examples of the method 200 are discussed below. The steps or operations of the method 200 are illustrated in a particular order for convenience and clarity; many of the discussed operations can be performed in a different sequence or in parallel without materially impacting other operations. The method 200 as discussed includes operations performed by multiple different actors, devices, and/or systems. It is understood that subsets of the operations discussed in the method 200 can be attributable to a single actor, device, or system could be considered a separate standalone process or method.

At step 202, phase change material can be mixed. At step 204, phase change material can be melted. At step 206, sheets of the mixed phase change material and the polymer can be formed. At step 208, the sheets of the phase change material and the polymer can be shredded to form shredded portions. At step 210, the shredded portions of the phase change material and the polymer can be extruded to form a composite filament 212. At step 214, the composite filament can be fed into a fused filament fabrication printer and at step 216 a heat exchanger 218 can be printed using the fused filament fabrication printer.

In some examples, the shredded portions can be preconditioned to a certain humidity and temperature prior to extruding. Optionally, a chamber surrounding the fused filament fabrication printer can be heated before printing the heat exchanger. In some examples, the filament can be screened for consistency prior to feeding the filament into the fused filament fabrication printer.

Optionally, the polymer can be a high-density polyethylene and the PCM can be an organic phase change material. In some examples, heat exchanger can be printed onto a high-density polyethylene build plate. Optionally, the heat exchanger can be separated from the high-density polyethylene build plate.

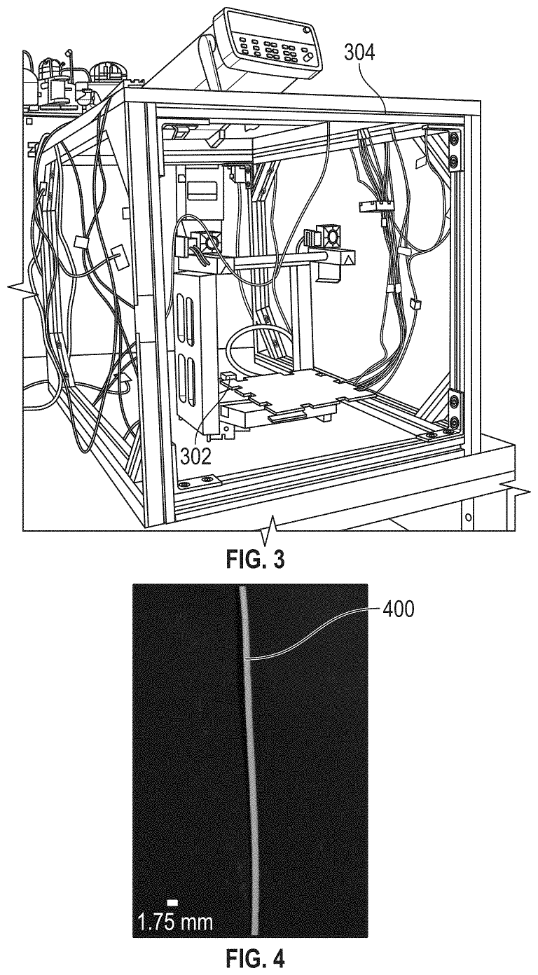

FIG. 3 illustrates a step of a manufacturing process where a chamber 304 can surround a 3D printer such as a fused filament fabrication (FFF) printer. In operation, the chamber 304 can be heated prior to or during printing of the heat exchanger to improve build quality. FIG. 4 illustrates a filament 400 that can be a product of printing using the methods discussed above. The filament can be a composite of a phase change material and a thermoplastic. For example, the filament can be a composite of a phase change material and high-density polyethylene.

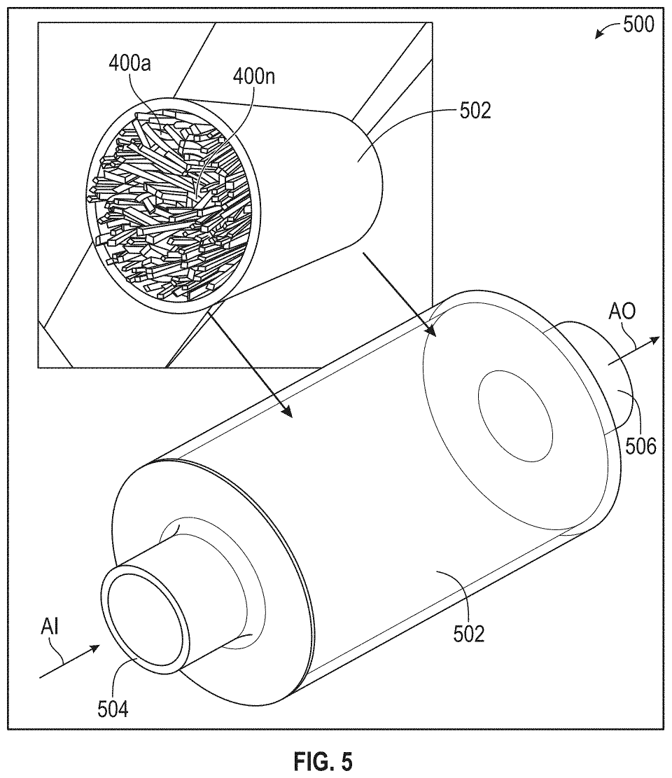

FIG. 5 illustrates a heat exchanger 500 using the filaments 400 of the manufacturing processes discussed above. The heat exchanger 500 can include a housing 502 defining an inlet opening 504 and an exhaust opening 506. The inlet opening 504 can be connected to a duct, tube, or pipe (such as in place of the PCM TES of FIG. 1). The inlet opening 504 can receive inlet air AI to the filaments 400 for energy transfer to or from the filaments 400. Following transfer, the inlet air AI can exit as outlet air AO (or exhaust air) from the heat exchanger outlet 506. In this way, the filaments can be used to create a relatively low-cost PCM TES.

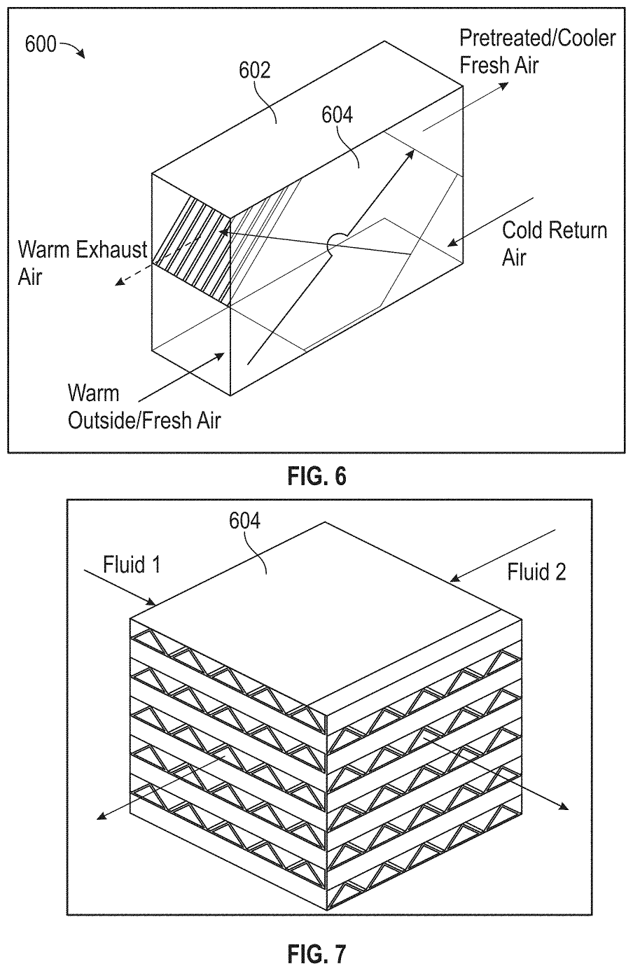

FIG. 6 illustrates a heat exchanger 600 that can be formed, at least in part, using the manufacturing processes discussed above. The heat exchanger 600 can include a housing 602 and a core 604. FIG. 7 shows the core 604. FIGS. 6 and 7 are discussed together below.

The core 604 can be manufactured using the process discussed above (the core 604 can be similar to the heat exchanger 218). The heat exchanger 600 can be a cross-flow type heat exchanger often used for exchanging heat between an exhaust air stream (e.g., fluid 1) and an outdoor air or fresh air intake airstream (e.g., fluid 2). In operation, energy from the exhaust air stream can interact with the core 604 to exchange energy with the core 604 and the PCM therein.

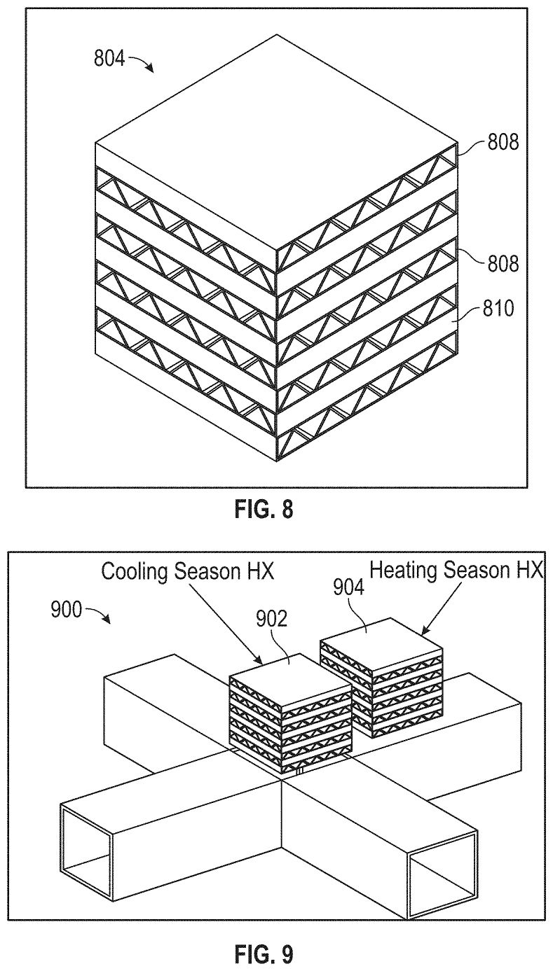

FIG. 8 illustrates a heat exchanger core 804 that can be produced using the manufacturing processes discussed herein. The core 804 can include a first layer 806, a second layer 808, and a third layer 810. The first layer 806 can be made of a first composite including a first phase change material configured to change phases at a first temperature. The second layer 808 can include a second phase change material configured to change phases at a second temperature that is different than (e.g., higher than) the first temperature. The third layer 810 can include a third phase change material configured to change phases at a third temperature that is different than (e.g., higher than) the first and second temperatures. For example, the first layer 806 can be optimized for energy exchange during heating (and can therefore be on top to receive the warmest air), the third layer 810 can be optimized for energy exchange during cooling mode (and can therefore be on the bottom to receive the coldest air) and the second layer 808 can be optimized for heating, cooling, or a temperature in between to perform sub-optimally but effectively in both heating and cooling modes.

FIG. 9 illustrates a heat exchanger system 900 where a cooling core 902 can be provided and a heating core 904 can be provided. The cooling core 902 can be optimized to exchange heat during a cooling mode and the heating core 904 can be optimized to exchange heat during a heating mode. The cores can be swapped in and out of the heat exchanger (e.g., heat exchanger 600) depending on whether it is cooling season (e.g., summer) or heating season (e.g., winter).

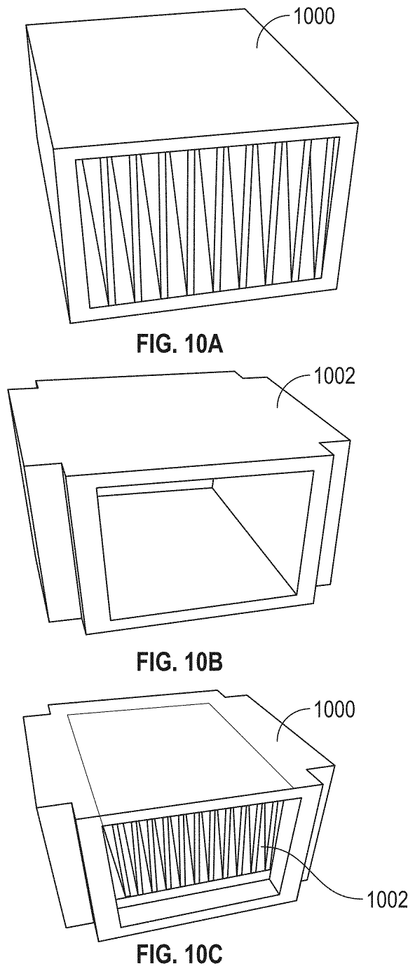

FIGS. 10A-10C illustrate a heat exchanger 1000 and a cartridge 1002. The heat exchanger 1000 can be similar to any of the heat exchangers discussed above or below. The heat exchanger 1000 of FIG. 10A can be 3D printed, such as by using a MakerGear M3-ID with G-code sliced using Simplify3D software. A pure HDPE heat exchanger and heat exchangers with mass ratios can be varied from 20% PCM and 80% HDPE (20/80) up to 40% PCM and 60% HDPE (40/60). Heat exchangers at increments of 10% can be printed. Each heat exchanger can have a custom cartridge printed, such as the one shown in FIG. 10B, to help ensure each heat exchanger can properly fit into a wind tunnel for testing purposes. The fit of the heat exchanger 1000 within the cartridge 1002 is shown, for example, in FIG. 10C, and each cartridge can be printed using Formlabs high temperature resin in a Formlabs Form 3B printer.

The heat exchangers can be designed or configured to have approximate dimensions of 1×1.25×1.5 inches (2.5×3.2×3.8 centimeters (cm)) and include eight 0.5 millimeter (mm) thick fins. The 20/80 and 40/60 heat exchangers can be slightly thinner at 0.75×1.25×1.5 inches (1.9×3.2×3.8 cm) but can have the same number of fins and similar or the same fin spacing. The cartridges for these heat exchangers can be adjusted to ensure proper wind tunnel fit. A 20/80 heat exchanger can be be compared to determine whether any results differ due to sizing. Additionally, a piece of each heat exchanger can be run on the 3 STARe, Mettler Toldeo DSC to determine the actual PCM/HDPE ratio.

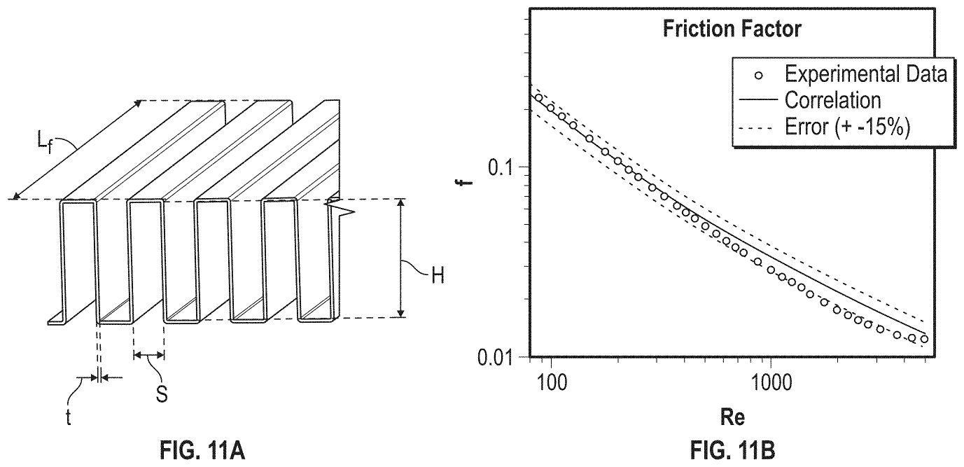

FIG. 11A illustrates a perspective view of a portion of a reference heat exchanger showing fin thickness t, fin height H, fin spacing S, and fin length L. FIG. 11B illustrates a chart comparing Reynolds numbers for tested heat exchanges versus friction factor f with error bars of ±15 percent, which provides pressure drop data for a heat exchanger manufactured using at least some of the methods discussed above or including at least some of the features discussed above.

The chart shows that the friction factor is about 0.15 below a Reynolds number of 100 and about 0.1 at a Reynolds number of about 200. The friction factor falls somewhat linearly (on the shown logarithmic scales) between 0 and 1500 Reynolds to about 0.012.

### ADDITIONAL EXAMPLE I

Further examples and analysis of the systems discussed above are discussed below in further detail.

Additively manufactured polymer heat exchangers are of interest in the thermal sciences due to their lightweight and intricate heat-transfer-enhancing geometrical features. The present application discusses directly encapsulating PCM into polymer filament for the purpose of 3D printing polymer heat exchangers capable of latent heat thermal energy storage and management. PCMs have the ability to absorb large amounts of latent heat while undergoing a solid-to-liquid phase change at a nearly constant temperature. Encapsulation or containment of PCMs can help prevent leaking since the material continuously cycles between a liquid and a solid state. An organic-based PCM and HDPE can be combined and extruded into a functional composite filament to demonstrate that these functional composite materials can be printed using FFF. Printing HDPE is known to be difficult; however, based on what was observed, the PCM and HDPE composite can be easier to print than pure HDPE. Thermal properties, such as latent heat of fusion, phase-change temperature, and thermal conductivity, of the composite filament and 3D printed samples were investigated and compared with compression-molded bulk material. The effective latent heat of fusion measurements helped evaluate the percentage of PCM in the composite material. The microstructures of the composite filament and 3D printed samples were visualized, and the basic structures of the HDPE and PCM within both the filament and 3D printed parts were clearly delineated.

PCMs have the ability to absorb large amounts of heat while undergoing a solid-to-liquid phase change at a nearly constant temperature. This characteristic makes them useful for thermal management and storage in various applications such as HVAC, regulation of photovoltaic panel temperatures, and thermal management of lithium-ion batteries. Organic (e.g., paraffins, plant-based, and fatty acids) and inorganic (e.g., water and salt hydrates) materials are popular in thermal energy storage systems. There are various advantages and disadvantages to each of these types of PCMs. Salt hydrates are gaining popularity; however, they are chemically unstable, do not melt congruently, and are highly corrosive. Furthermore, since they are hydrophilic and their water content tends to alter easily, they are difficult to encapsulate. Encapsulation or containment of PCMs is useful to prevent leakage since the material continuously cycles between liquid and solid phases. Sealing organic PCMs such as paraffins can be difficult due to materials compatibility issues.

The geometries of the components considered were previously impossible if made by traditional manufacturing techniques such as casting, extrusion, or injection molding. Although polymers may seem like an unconventional material, they have many advantages over more traditional metal heat exchangers. Polymer heat exchangers can be lighter, electrically insulative, more durable with regards to chemicals, corrosion resistant, and relatively lower in cost to produce. Issues, such as low thermal conductivity, can be mitigated by shrinking wall thickness and/or adding thermally conductive fillers such as carbon nanotubes or metallic, ceramic, and carbon fibers.

In order to additively manufacture a thermal energy storage system using FFF, the PCM must first be combined with a compatible polymer to shape stabilize the PCM. The polymer should have a higher melting point, so that the PCM remains contained within the polymer matrix when melted. Many polymers are incompatible because popular types of organic PCMs typically contain hydrocarbons, which make sealing PCMs difficult; however, it has been found that high-density polyethylene (HDPE) is compatible with a lot of different types of organic PCMs.

HDPE is used in the present application as part of the FFF feedstock material for several reasons. First, HDPE is compatible with many types of organic PCMs that can react and perform well after being shape stabilized. More common FFF feedstock material such as acrylonitrile butadiene syrene (ABS) and polylactic acid (PLA) were tested with PCM in the current study, however, they were observed to be immiscible. Second, HDPE can be extruded from recycled containers without the use of additives or modifications. The thermal and mechanical properties of the filament under different processing conditions for printed and molded samples for recycled HDPE filament are a suitable replacement for commercial filament. To help address these issues, shape-stabilized organic PCM (PureTemp 42) with HDPE can be printed using FFF. The functional composite filament, which is capable of thermal energy storage, can be fabricated and printed using low-cost desktop equipment.

### 2 Materials and Manufacturing Methods

### 2.1 Materials

HDPE pellets (PPR-HDPE01) can be supplied from Premier Plastic Resins (Lake Orion, Mich.) with a specific gravity of 0.955 and a melt flow rate of 20 g/10 min (190° C. and 2.16 kg). The PCM, PureTemp 42 (henceforth known as PCM42), can be supplied from PureTemp (Minneapolis, Minn.). PCM42 has a theoretical phase-change temperature of 42° C. and latent heat of fusion (hsl) of 218 kJ/kg. The latent heat of fusion is the energy absorbed or released during a constant-temperature phase change from a solid to a liquid. When PCM42 is in the solid phase, it has a density (ρ) equal to 940 kg/m\hat{ }3 and a thermal conductivity (k) equal to 0.25 W/m·K. When PCM42 is in the liquid phase, it has a density equal to 850 kg/m\hat{ }3 and a thermal conductivity equal to 0.15 W/m·K.

### 2.2 Filament Fabrication

Mixtures of HDPE and PCM42 can be prepared by pre-melting and mixing the two materials together for specific mass ratios. The thermal storage capacity can correlate to the PCM percentage within the composite; however, too much PCM content can diminish the structural integrity. The mass content of the PCM42 in the mixture can be varied between 20-60%, such as in increments of 10%, in order to determine the maximum amount of PCM42 that can be mixed with HDPE to produce filament suitable for FFF. The mixtures were observed for consistency of filament diameter during the extrusion process and their ability to remain flexible enough for printing (i.e., could physically be handled without breaking). If the percentage of PCM42 in the mixture was too high, then an inconsistent diameter was observed during the process, and the resultant filament would break easily when handled. It was discovered that the 40% PCM42 mixture contained the maximum amount of PCM while still maintaining the criteria for printable filament; therefore, this composition was selected for further study. The DSC was used to examine the filament by testing the latent heats of fusion and melt temperatures of both the PCM42 and the HDPE in the composite. As will be discussed later, the DSC results can also be used to hypothesize the amount of PCM loss due to the extrusion process (e.g., leaking).

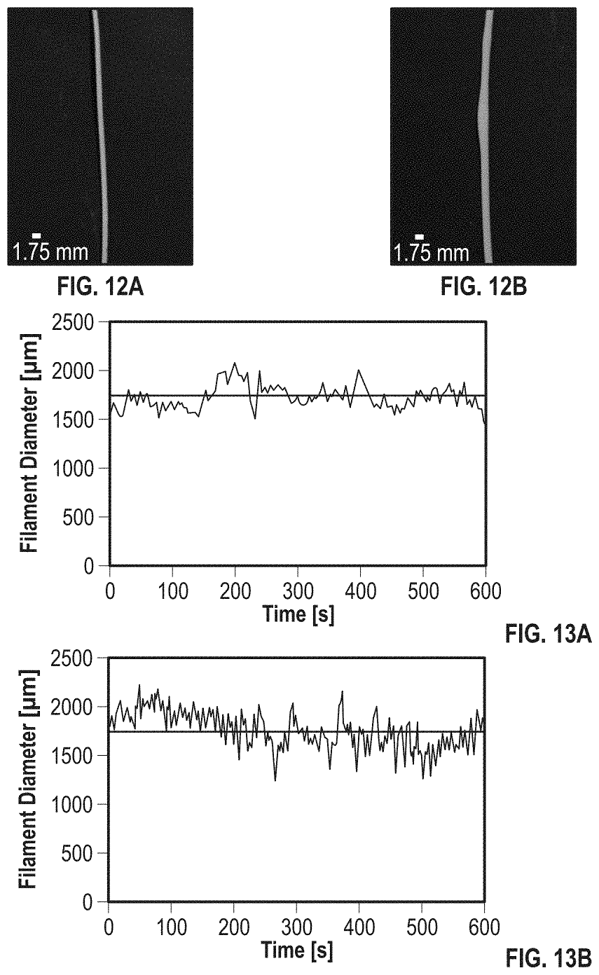

The 40/60 composite can be pelletized using a shredder (SUR3D IT, 3devo, Utrecht, Netherlands) and extruded into 1.75-mm-diameter functional composite filament using a filament extruder (Next 1.0, 3devo, Utrecht, Netherlands) with a 4-mm-diameter nozzle. The extruder can include four equally spaced independent heating elements and a single screw to help promote better mixing. At the nozzle outlet of the extruder, there can be two adjustable directional fans for air cooling. During the extrusion process, the filament diameter can be affected by a number of factors, such as the cleanliness of the machine (blockages), heating element temperatures, the speed of the screw, and nozzle diameter. Therefore, an initial set of experiments can be used to optimize the extruder settings for pure HDPE and the 40/60 composite. The heater temperatures, screw speed, and filament diameter can be monitored throughout each extrusion process. FIGS. 12A and 12B illustrate perspective views of a filament where FIG. 12A shows a filament with consistent diameter and FIG. 12B shows a filament with inconsistent diameter.

Consistent-diameter filaments can be produced using optimal settings, discussed below, after starting with an extruder that had been purged with specialized cleaning materials (HDPE Flush, Devoclean Purge, 3devo, Utrecht, Netherlands). Inconsistent-diameter filament can arise from any combination of not using optimal settings, starting with an uncleaned extruder screw, and/or too much PCM42 in the mixture (discussed earlier). As a reference, the filament diameter of pure HDPE and the 40/60 composite can be measured over a ten-minute time period, as shown in FIGS. 13A (pure HDPE) and 13B (40/60 PCM and HDPE composite). The 40/60 composite can have slightly more variance in filament diameter than pure HDPE, which can cause inconsistencies within the print, but can still be useable for FFF purposes.

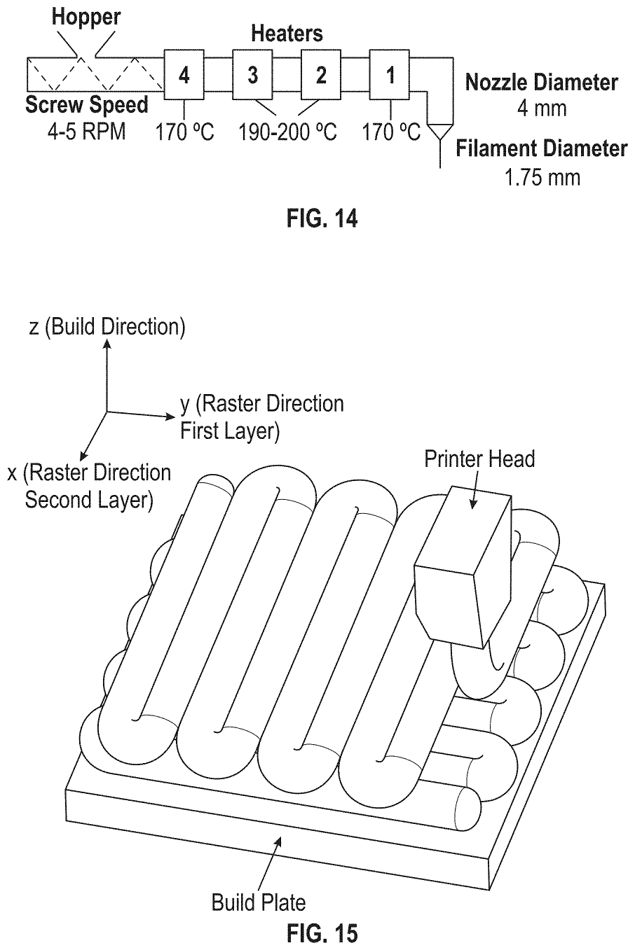

Common extrusion practice can use a balance between the temperature of the material and flow through the nozzle. The amount of PCM content can affect the settings required to produce the desired filament diameter. Heater temperatures can be between 170 and 210° C. to help ensure the filament properly melts, but does not burn, and screw speeds can be set between 3 and 6 RPM to adequately move material. Adjustments can be made based on the analysis of the filament diameter. From this analysis, the settings that produced the most consistent filament diameters for pure HDPE and the 40/60 composite are shown in FIG. 14, which shows the screw speed, heater temperatures, and nozzle diameter. Due to the incorporation of PCM42, the 40/60 composite settings are ideal at the lower heater temperatures (190° C.) and screw speed (4 RPM), whereas the pure HDPE can extrude best at the higher ranges (200° C. and 5 RPM). Additional factors such as blockages within the extruder and heavy directional cooling (from the cooling fans) can influence the consistency and shape of the filament. From the optimal parameters provided, the settings can be altered further depending on the response of the material at the specific time of extrusion.

### 2.3 Additive Manufacturing

Pure HDPE and shape-stabilized 40/60 PCM42 and HDPE samples can be 3D printed using a MakerGear M3-ID (Beachwood, Ohio) with G-code sliced using Simplify3D software. The print settings are shown in Table 1, below, and the general pathing of the G-code for the samples is shown in FIG. 15, which shows a schematic diagram of the material deposition process. When printing HDPE using FFF, adhesion and detachment can be difficult due to the high shrinkage of the material.

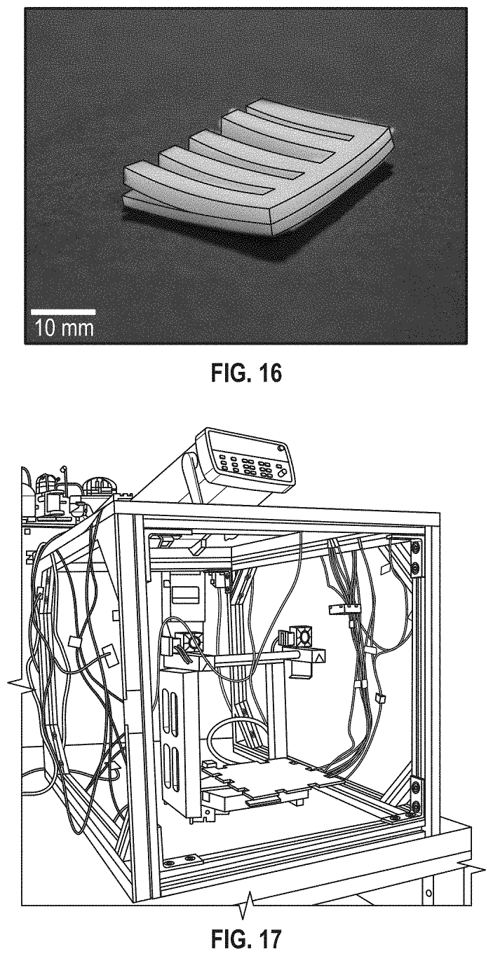

In the current study, a heated HDPE build plate was also used; however, a smooth build plate provided good adhesion with minimal curling for pure HDPE filament, so roughening or a SEBS build plate was not necessary. Delamination between the layers and curling can be observed during the printing of larger HDPE samples, as seen in FIG. 16. The delamination and subsequent curling can be caused by a temperature disparity between the extruded material (˜240° C.) and the ambient printing environment (25° C.). To help mitigate the delamination issue, the print operation can be moved further away from the heated build plate using an elevated-temperature environment, similar to what others have implemented in previous work (as shown in FIG. 17). Successful printing was observed for heated-environment temperatures between 60° C. and 65° C. The elevated temperature significantly improved the bonding of the layers and reduced curling and delamination, thereby reducing the frequency of failed prints.

TABLE 1
Print Settings

| Setting | Value |
|---|---|
| Nozzle Diameter | 0.35 mm |
| Nozzle Temperature | 240° C |
| First Layer Thickness | 0.18 mm |
| Layer Thickness | 0.20 mm |
| Line Width | 0.42 mm |
| Fill Percentage 100% | 100% |
| Material Flow | 1.00* |
| Build-Plate Temperature | 60° C |
| Filling Pattern | Lines, 45° Offset Alternating |
| First Layer Printing Speed | 550 mm/min |
| Printing Speed | 1100 mm/min |

*Adjusted to 1.05 when filament diameter is undersized

Although the heated HDPE build plate was successful in promoting good adhesion, the print became difficult to remove since the first layer was fused to the build plate. In the present study, initial prints resulted in the bottom of each sample being destroyed during the removal process. A design modification can be used to help with this issue by adding extra depth to the sample disks and, when required, the final surface can be sanded until a desired surface finish and/or dimension was attained. The shape-stabilized functional composite prints can have noticeably less curling and can be easier to remove from the build plate than pure HDPE prints, which suggests that the PCM reduced the affect of these issues. Any printing problems with the 40/60 composite are often caused by inconsistent filament quality or issues introduced by the heated enclosure, which can cause either obstructions in the nozzle or under-extrusion of the sample. These issues can be resolved by visually screening the filament before use and increasing the material flow when the diameter was significantly below the nominal 1.75 mm (see FIG. 14).

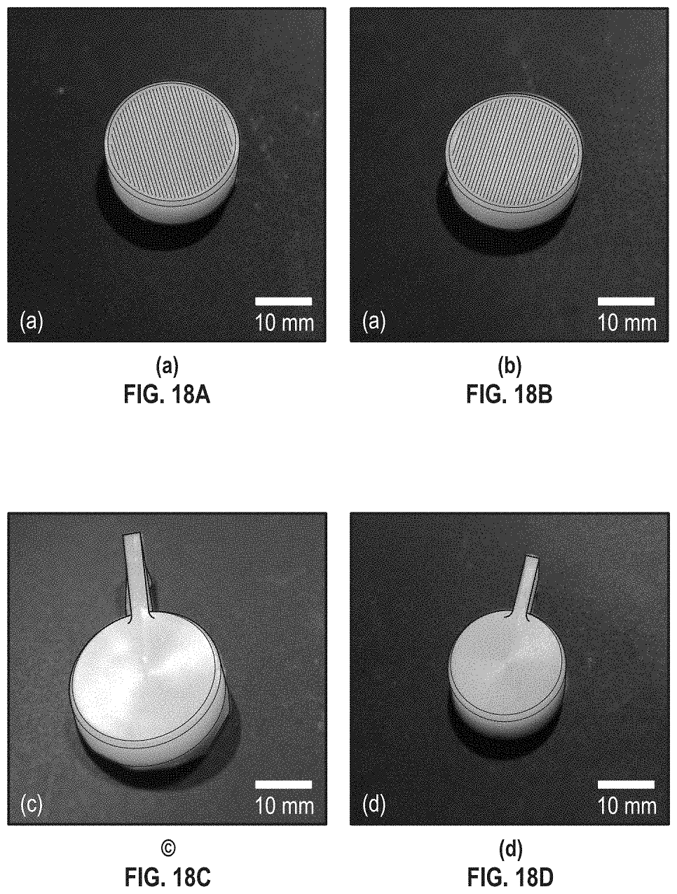

In the heated environment, the 40/60 composite feedstock can become slick with PCM since the ambient temperature inside of the heated enclosure can be greater than the phase-change temperature (42° C.). Despite the aforementioned difficulties, multiple disk samples (25-mm diameter and 4-mm thick) were successfully printed, which can be seen in FIGS. 18A and 18B, showing a HDPE sample and a PCM42/HDPE composite, respectively. The slick filament cab create extruder clogs, but a slower print speed can help to reduce the frequency of this issue.

### 2.4 Molding of Bulk Samples

A custom machined mold can be used to create bulk material samples used as the baseline for the thermal characteristics of the printed samples. The bulk material samples can be made to have the same dimensions as the 3D printed samples. The 40/60 PCM 42 and HDPE composite, the pure HDPE, and the pure PCM 42 can be melted down and compression molded into 25-mm-diameter and 4-mm-thick disks. Processing temperatures for the pure HDPE and 40/60 composite can be around 200° C. Example molded samples for both the HDPE and the 40/60 composite are shown in FIGS. 18C and 18D, showing a molded HDPE sample and a molded PCM42/HDPE composite, respectively.

### 3 Experimental Methods

### 3.1 Differential Scanning Calorimetry

The latent heat of fusion and phase-change temperature of the 40/60 PCM42 and HDPE composite filament material can be measured using a DSC (DSC 3 STARe, Mettler Toldeo, Columbus, Ohio). The masses of five random samples from the filament can be measured using a balance (XS105DU, Mettler Toledo, Columbus, Ohio). The samples, ranging in mass between 6 and 18 mg, can be placed in 40 micro liter (μl) aluminum crucibles. The temperature of each sample can be initially held at 10° C. for 10 min and then heated from 10 to 200° C. at 2° C./min. Each sample can be held at 200° C. for 10 min and then cooled at −2° C./min until it reaches a temperature of 10° C. Temperature and heatflow can be recorded every one second. This heating and cooling cycle can be performed at least two times to help each sample melt down once to make good thermal contact with the bottom of the crucible before the actual measurement.

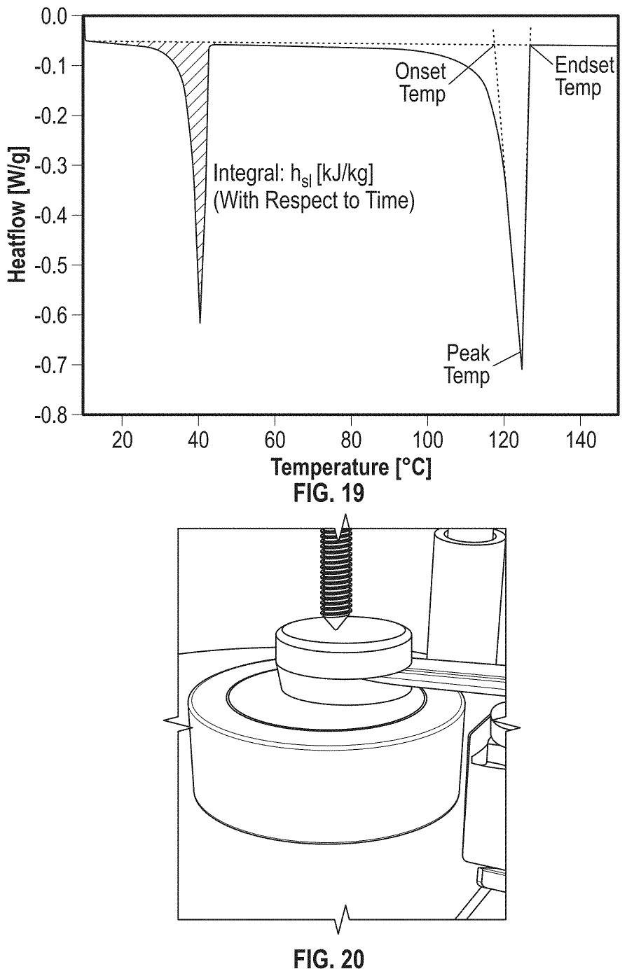

Since the PCM42 material is not a pure substance, the phase change can happen over a range of temperatures and not just over a single temperature (as is observed in a pure substance). The melting temperature range of the 40/60 composite can be calculated based upon the onset and endset temperatures from the heatflow versus temperature graph as shown in FIG. 19. The onset and endset temperatures are the temperatures where the material begins and ends the melting phase, respectively. These temperatures can be defined as the intersections of the inflectional tangents of the leading and trailing edges of the peak and the extrapolated tangent of the baseline. The latent heat of fusion can calculated by the area under the peak of the heatflow versus time curve.

### 3.2 Thermal Conductivity Measurements

A thermal constants analyzer (such as the Transient Plane Source (TPS) 2500S, Hot Disk, Gothenburg, Sweden) can be used to measure the thermal conductivity of the 40/60 PCM42 and HDPE composite bulk material and the printed samples. The isotropic module with a 4-mm-diameter Kapton sensor (C7577, Hot Disk, Gothenburg, Sweden), which can include both a resistive heater and a temperature sensor, can be used. The sensor can be sandwiched between two matching 25-mm-diameter and 4-mm-thick samples made of the same material and identically manufactured (see FIG. 20). Joule heating can be applied, which can produce a dynamic temperature field in the sample and sensor. The temperature response of the sensor can monitored, and the thermal conductivity of the sample can be determined from a model. A power of 50 mW and time of 10 s can be used. For statistical significance, ten tests can performed for each sample to obtain an average thermal conductivity and standard deviation.

### 4 Microscopy

The microstructures of the 40/60 PCM42 and HDPE composite filament and resultant prints can be visualized using a scanning electron microscope (SEM, Quanta 650, ThermoFisher Scientific, Hillsboro, Oreg.). To allow for high-vacuum setting used for visualization, the samples can be coated in gold (Sputter Coater 108, Cressington Scientific Instruments, Watford, UK). An accelerating voltage between 15 kV and 20 kV can be used, and the vacuum pressure can be between 15 and 8×10 \hat{ }(−6) Torr. To observe the cross section of the filament and printed samples, liquid nitrogen can be used to freeze the samples before shattering.

### 5 Results and Discussion

### 5.1 Phase-Change Temperature and Latent Heat of Fusion

The 40/60 PCM 42 and HDPE composite filament can be extruded and samples can be taken from five randomly selected regions throughout the extrusion process. Results are shown in Table 2 for each of the five samples that was tested in the DSC to measure the average and standard deviation of the phase-change peak temperature Tpeak, onset temperature Tonset, and endset temperature Tendset. Values of the five samples and the standard deviation show that the material composition is fairly consistent throughout the extrusion process.

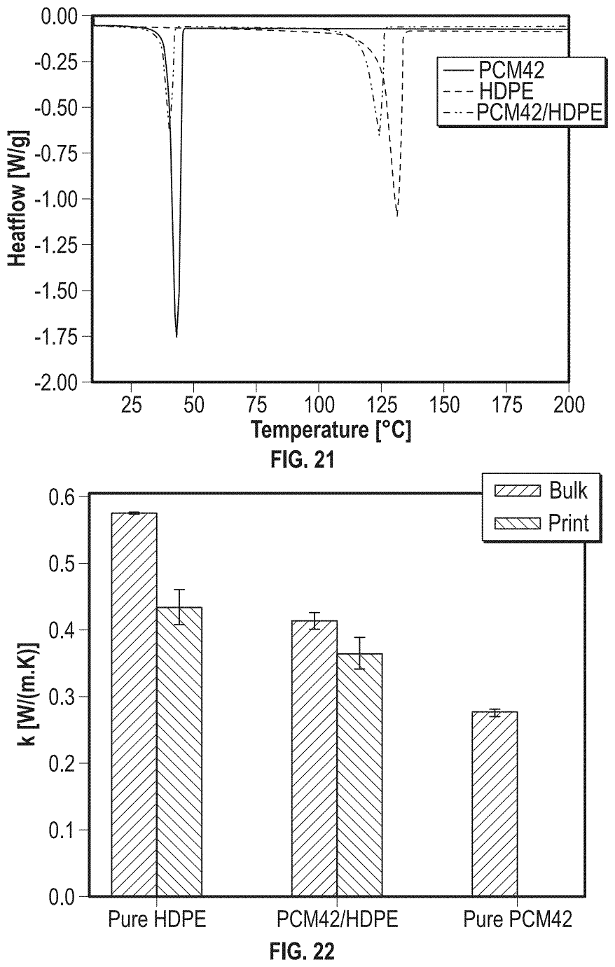

The phase-change peaks for the pure PCM42, pure HDPE, and 40/60 composite filament are shown in FIG. 21 showing heatflow versus temperature for pure PCM42, pure HDPE, and the PCM42/HDPE composite filament. In FIG. 21, the first peak represents the phase change of PCM42 around 42° C., and the second peak represents the phase change of the HDPE around 130° C. Effective latent heats of fusion hsl for both the PCM42 and HDPE in the composite were also calculated by integrating the area under the peaks with respect to time in FIG. 21. Baseline samples for pure PCM42 and pure HDPE are represented in the table as pure.

The latent heat of fusion for the pure PCM42 is approximately 9% lower than the published value of 218 kJ/kg. The latent heats of fusion for both the PCM42 and the HDPE are very close in value, where the HDPE latent heat of fusion is approximately 5% less than the PCM42 value. Based upon the results in Table 2, shown below, the 40/60 composite filament has an average effective hsl for PCM42 of 63.66 kJ/kg. This value is only 31.8% of the latent heat of fusion of 200.00 kJ/kg for pure PCM42. it is hypothesized that if there is 40% of the PCM42 in the filament, the effective hsl should be 40% of 200 kJ/kg, which is 80 kJ/kg. The difference between the true value and the hypothesized value may be due to multiple factors, such as material loss during the mixing and extrusion processes involved in the fabrication of the composite filament, the chemistry of mixing the materials, or a combination of both. Regardless, the thermal energy storage capability of the composite filament effectively acts as if there is 31.8% of the pure PCM42 in the composite.

According to the results (Table 2 and FIG. 21), the 40/60 composite filament causes the peak, onset, and endset temperatures to decrease. The peak melting temperature for pure PCM42 is 44.47° C., compared to the average peak melting temperature of 40.60° C. for the PCM 42 in the composite. An even greater decrease in melt temperature for the HDPE in the 40/60 composite is observed, with pure HDPE having a peak melting temperature of 133.33° C., and the HDPE in the 40/60 composite having an average peak melting temperature of 124.35° C. This phenomenon can help explain why the composite required lower temperatures during the extrusion process as compared to the extrusion temperatures of the pure HDPE (see FIG. 14).

TABLE 2

| | PCM42 | | | | HDPE | | | |
|---|---|---|---|---|---|---|---|---|
| | Tpeak | Tonset | Tendset | Hsl | Tpeak | Tonset | Tendset | Hsl |
| | (° C.) | (° C.) | (° C.) | (kJ/kg) | (° C.) | (° C.) | (° C.) | (kJ/kg) |
| Pure | 44.47 | 40.36 | 46.28 | 200 | 133.33 | 125.95 | 136.75 | 191.68 |
| Sample 1 | 40.70 | 37.67 | 42.51 | 59.94 | 124.59 | 118.38 | 126.54 | 116.42 |
| Sample 2 | 40.58 | 37.68 | 42.49 | 60.02 | 124.50 | 118.66 | 126.37 | 118.27 |
| Sample 3 | 40.55 | 37.63 | 42.43 | 62.68 | 124.43 | 118.36 | 126.39 | 123.30 |
| Sample 4 | 40.61 | 37.61 | 42.48 | 63.28 | 124.44 | 118.41 | 126.50 | 122.91 |
| Sample 5 | 40.58 | 37.82 | 42.66 | 72.40 | 123.78 | 117.79 | 125.67 | 117.87 |
| Sample | 40.6 | 37.68 | 42.51 | 63.66 | 124.35 | 118.32 | 126.29 | 119.75 |
| Average | | | | | | | | |
| Sample St. | 0.06 | 0.08 | 0.09 | 5.11 | 0.32 | 0.32 | 0.36 | 3.14 |
| Dev. | | | | | | | | |

### 5.2 Thermal Conductivity

Each sample can be measured ten times to determine an average thermal conductivity and standard deviation, and the results can be seen in Table 3. FIG. 22 displays the information in a bar graph for comparison purposes. In the figure, the error bars represent the standard deviation. The pure PCM42 does not have a print value due to the inability to print pure PCM42 without a shape stabilizer. Based upon the results, it can be seen that pure HDPE and pure PCM42 in their bulk forms have a measured thermal conductivity of 0.576 W/(m·K) and 0.276 W/(m·K), respectively. The thermal conductivity value for the PCM42 is 10.4% higher than the values provided by the manufacturer, which was 0.25 W/(m·K). The thermal conductivity of the molded bulk 40/60 PCM42 and HDPE composite was measured to be 0.413 W/(m·K). This value corresponds to a 28.3% decrease in the original thermal conductivity of the HDPE, which shows that the addition of the PCM42 mixed into the HDPE causes the overall thermal conductivity to be lower than the value of the pure HDPE based upon the amount of PCM added by mass. From the DSC results, it was shown that the composite has a mass content of PCM close to 30%, and the 28.3% decrease in thermal conductivity further supports that conclusion. Therefore, the thermal conductivity of the composite is expected to decrease in proportion to the amount of PCM that is added to the composite.

TABLE 3
Thermal conductivity (average of each sample
measured 10 times) of the molded and printed samples

| Sample | k [W/(m*K)] | St. D |
|---|---|---|
| Bulk Pure HDPE | 0.576 | 0.001 |
| Bulk 40/60 PCM42 and HDPE Composite | 0.413 | 0.013 |
| Bulk Pure PCM 42 | 0.276 | 0.005 |
| Printed Pure HDPE | 0.435 | 0.026 |
| Printed 40/60 PCM 42 and HDPE Composite | 0.365 | 0.024 |

The printed pure HDPE and printed PCM42/HDPE composite can be measured to have thermal conductivities of 0.435 W/(m*K) and 0.365 W/(m*K), respectively. These values are noticeably lower than the respective thermal conductivities of the bulk materials. The reason that the printed materials have a lower thermal conductivity than their bulk counterparts is because of air gaps that can form within the printed part from the actual printing process. The small air gaps can cause thermal contact resistance between the layers. Based upon the current state of FFF, air gaps within the printed part will always be present, although some recent efforts have been made to reduce this effect. The thermal conductivity of the printed part can change based upon the size and quantity of these air gaps, which can be highly dependent on print settings. The printed HDPE was 24.5% lower than that of the bulk value, and the printed composite was 11.6% lower than the bulk composite. The smaller difference in thermal conductivity between the bulk and printed composite compared to the pure HDPE bulk and printed samples can be due to PCM42 filling in the air gaps during the printing process. Evidence of this is shown in the microstructure visualization results.

Another reason for the decrease in thermal conductivity for the printed material can come from the surface quality of the printed part versus that of a molded version of the same material. Similar to the reasons for why the air gaps can be formed within the material, the FFF process can result in a poor surface finish depending upon the printing parameters. A poor surface finish can lead to poor thermal contact with the respective heating source (Kapton sensor) used to make the measurement, which can inherently lower overall measured thermal conductivity. Without any post processing, such as sanding, the printed samples can have a noticeably rougher surface finish than the molded samples, which can be seen in FIGS. 18A-18D.

### 6 Microstructure Visualization

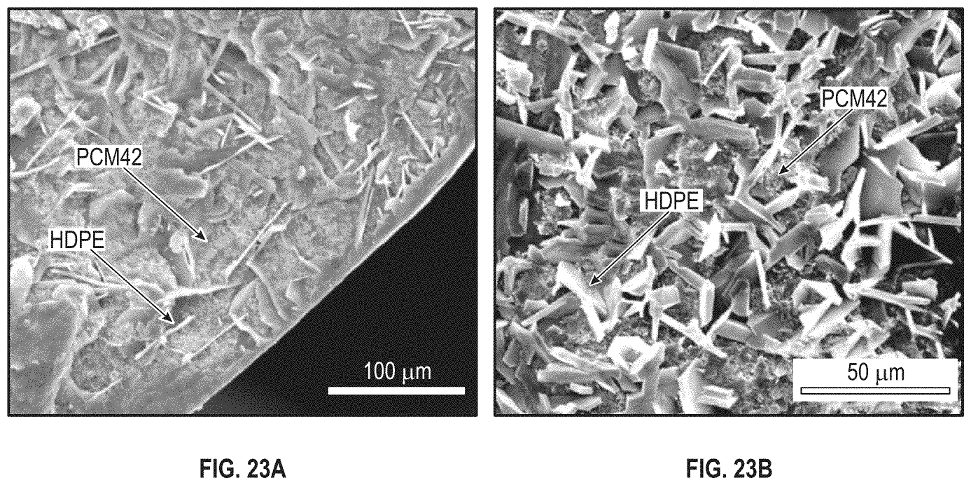

A cross-sectional view of the extruded 40/60 PCM42 and HDPE composite filament (before FFF) is shown in FIGS. 23A and 23B, including respective scale bars of 100 micrometers (μm) and 50 μm, respectively. Microstructure images of the pure materials are shown to be differentiated, where pure extruded HDPE has a platelet-like structure and PCM42 can have a cloud-like structure. FIG. 23A shows the filament magnified 925 times with the edge visible, and FIG. 23B shows the filament magnified 2000 times. The platelet-like structure of the HDPE can be seen with the PCM encapsulated in between the platelets. Based upon visual inspection, the mixing of the two materials can produce a homogeneous filament.

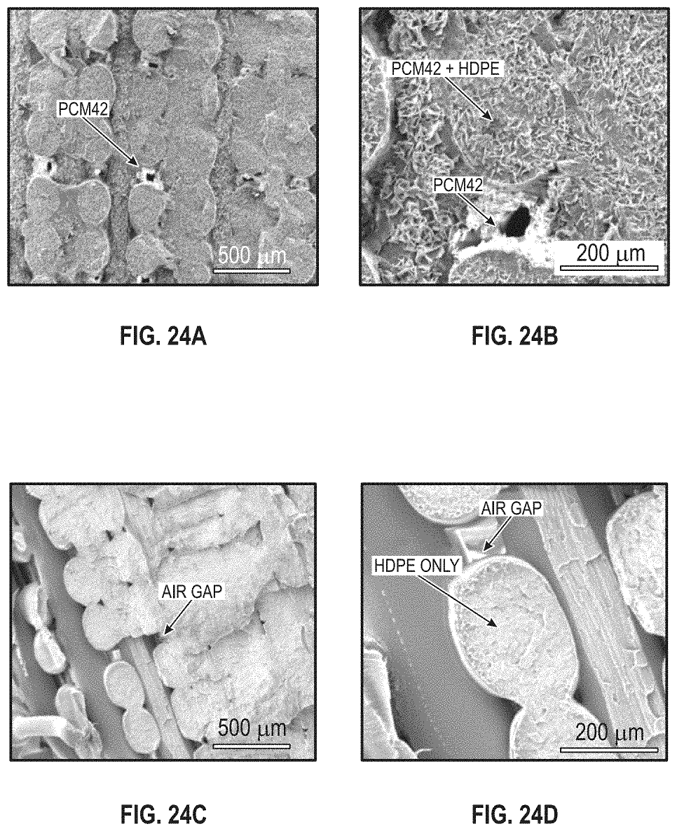

The fracture surface (cross-sectional view) of both the 40/60 composite and pure HDPE printed samples at different magnifications can be seen in FIGS. 24A-24D. While FIGS. 24A and 24C show the printed 40/60 composite for different magnifications, FIGS. 24B and 24D show the printed pure HDPE for corresponding similar magnifications. The 40/60 composite material retained its basic microstructures after the second extrusion of the material during the FFF process.

Also in FIGS. 24A-24D, the print directions and print patterns can be clearly observed, and noticeable air gaps, formed by the printing process between parallel beads of material, can be seen. Despite having an infill percentage of 100% for both samples, small air gaps can still be present within the printed material. The air gaps are one of the main reasons for the reduction in thermal conductivity in the printed samples when compared to the bulk material thermal conductivity. The presence of air gaps can cause a decrease in thermal contact from one layer to the next, therefore causing a decrease in overall thermal conductivity. As the amount and size of air gaps increase for a given print, the thermal conductivity is expected to decrease proportionally.

It can be observed in FIG. 24C that when the 40/60 composite is printed, the air gaps become partially filled with the PCM42. This can cause a reduction in air-gap size, which in turn leads to less of a decrease in thermal conductivity. The air gaps formed when printing pure HDPE can be seen in FIGS. 24C and 24D and when compared to the printed composite, appear to be more prominent. The effects of these different air gaps can also be observed in FIG. 12, with the difference in thermal conductivity from bulk-material-to-printed having a greater decrease with pure HDPE versus the 40/60 composite.

### 7 Concluding Remarks

A shape-stabilized PCM and HDPE functional composite can be printed using FFF. A composite comprising 40% PCM42 and 60% HDPE by mass can be mixed and extruded to make filament that is capable of significant thermal energy storage. It can be determined through DSC testing that the thermal storage capability of the resultant filament effectively behaved as if there was 31.8% of the PCM42 in the composite. Furthermore, the filament can be printed into sample specimens for further thermal testing. Utilizing SEM, the microstructures of the 40/60 PCM42 and HDPE composite material can be investigated after the first extrusion (filament making) and after the second extrusion (printing), and it can be found that the material retained the same form after multiple extrusions. A heated HDPE build plate and heated enclosure can be used to improve the print process of HDPE and the 40/60 composite. Although there are many known difficulties in printing pure HDPE, the added PCM helped make the process easier. Phase-change temperature, effective latent heat of fusion, and thermal conductivity were measured and reported.

### ADDITIONAL EXAMPLE II

Thermal energy storage, in the form of chilled water or ice-based phase-change systems, has been used in commercial buildings for over 30 years. These systems can take advantage of off-peak electricity rates to cool water or ice at night, which can provide cooling power during the day, such as when the electricity prices are at their peak. Although these systems work well for buildings, they may not be feasible for residential use, at least in part due to the fact that a residential system supplies air at 55° F., which can be too high of a temperature to take advantage of the latent heat of melting for water, which freezes and melts at 32° F. Alternative phase-change materials (PCMs) can be used for residential applications. Direct implementation of PCM can be problematic due to the nature of PCMs cycling between solid and liquid states during normal operating temperatures. Encapsulation of the phase-change material, typically in a polymer, can help to maintain structural shape stability during the melting and solidification of the material. Polymers used for encapsulation help maintain the shape of the material as well as retain the PCM within the polymer during the phase change. Coincidentally, polymer heat exchangers and additive manufacturing are also of rising interest. Polymer heat exchangers boast a number of benefits including weight reduction, natural corrosion resistance, and anti-fouling when exposed to typical process fluids. This disclosure includes an analysis on the effectiveness of the novel polymer PCM thermal energy storage heat exchanger with comparisons to traditional materials.

### Introduction

Thermal energy storage (TES) in building applications has been a topic of research for a few decades. TES systems have been around since ancient times in Rome and Greece where snow was transported from the mountains to cities in order to cool beverages. Thermal energy storage for cooling became very popular in the mid-1800's where blocks of ice were cut from frozen lakes and shipped to warmer climates in insulated rail cars for food preservation and health care.

The two main forms of TES, in modern day building applications, are ice storage and hot water storage. Hot water storage is used in many residential building applications by storing large amounts of water and keeping this water at higher temperatures for more efficient on demand hot water needs. The other modern use of TES is more commonly seen in commercial or large buildings that require massive amounts of cooling throughout the day. These large buildings create ice at night to help lower the cooling load during the day by melting the ice. Ice storage does not actually lower the amount of electricity used throughout an entire day cycle, but allows for electricity to be used at different times. This practice is commonly referred to as “peak shaving.” Electricity does not have the same cost at every time throughout the day because there is a supply and demand associated with how and when electricity is used. The highest demand for electricity is during the day when use is highest and when the day is hottest (cooling loads are highest), so energy cost is higher during these times. Conversely, at night when the temperature is lower and people are asleep and not using much electricity, energy cost is reduced to compensate for lack of demand. The day time hours electrical loads are commonly referred to as “on-peak” electrical loads, while night time hours electrical loads are referred to as “off-peak” electrical loads. The act of “peak shaving” is to reduce the electrical loads during the “on-peak” hours and shift these demands to the “off-peak” hours.

For commercial and large buildings, cooling loads from air conditioning account for nearly 30% of the energy loads throughout the day and are usually the largest electrical cost for operation of such buildings. These buildings often use large chiller units for their cooling demands that are on the order of magnitude of 1000 tons of cooling or greater. With the use of an ice storage system, the large amount of latent heat capacity for ice is used to help reduce the cooling load on the chiller during on-peak hours. Commercial building chillers can operate around the phase-change temperature of water (32° F.), which can make it convenient to use ice storage for these applications. When it comes to residential HVAC applications, the phase-change temperature of 32° F. is lower than the typical supply air discharge temperatures (approximately 50-55° F.) of a residential cooling system. To achieve the benefit of peak shaving on the residential scale, alternative phase-change materials (PCMs) with higher phase transition temperatures than water can be explored.

There are many alternatives to water as a PCM. Other PCMs can be broken into three different categories; organic, inorganic, and eutectic PCMs. The two main PCMs for consideration for residential HVAC applications are organic and inorganic PCM. Examples of organic PCMs include paraffin waxes, non-paraffin waxes, and fatty acids. The advantages of organic PCMs include their wide range of available phase-change temperatures, non-corrosive nature, minimal to no phase segregation, low degradation of latent heat of fusion over many cycles, and self-nucleation (no supercooling). Disadvantages include low thermal conductivity, low flash points, varying levels of toxicity, and instability at high temperatures.

Inorganic PCMs include salts, salt hydrates, metals, and alloys. Most inorganic PCM have very high melt temperatures, i.e., salts, metals, and alloys, while salt hydrates can be formulated to have a lower phase-change temperature than that of the individual salt component. So, of the many inorganic PCMs, salt hydrates are the more than likely candidate material for residential cooling. The main advantage to salt hydrates over most organic PCM, is that salt hydrates have a higher on average latent heat energy capacity. Unfortunately, there are a few large disadvantages that come from using salt hydrates. These disadvantages include corrosive nature, phase segregation, low thermal conductivity, very poor self nucleating (supercooling), and a lack of thermal stability. Based upon current research expertise of the authors, use of organic PCMs are explored with a focus on encapsulated and implement within polymer heat exchangers.

Due to the very nature of PCM, when these materials undergo their phase-change, a means to contain the material as it transitions from a solid to liquid is required. Different containment methods can be classified as core-shell encapsulation (CSE) or shape-stabilized PCMs (SSPCM). CSE is simply where the PCM is the core structure that is surrounded by a shell of a material that forms and maintains the shape of the whole structure. These CSE structures can be as simple as a sealed container filled with PCM or can be as complex as an emulsion polymerization on the nano scale. SSPCM are PCMs that are combined with another material (i.e. mixing, infiltration, impregnation, etc.), where the non-PCM material acts as a matrix to maintain the shape of the PCM as it undergoes the phase-change process.

One method for the encapsulation of organic PCM considered here, is the direct mixing of organic PCM with the polymer high-density polyethylene (HDPE) as a SSPCM. Here, the method of shape-stabilized encapsulating organic PCM into HDPE is explored through the same method as creating filament for additive manufacturing (AM), in an attempt into the capability of 3D printing SSPCM into a polymer heat exchanger for TES applications.

Research into the applications of polymer heat exchangers as a suitable replacement to non-polymer heat exchangers (e.g., made from traditional metals such as copper and aluminum) has been an ever growing topic over many years. The first polymer heat exchanger was developed in 1965. It consisted of a flexible tube bundle of 650 Teflon tubes, which are corrosion, fouling, and scaling resistance. Polymer heat exchangers boast a number of benefits including weight reduction, natural corrosion resistance, and anti-fouling when exposed to typical processing fluids. The most notable disadvantage of using polymers for heat exchanger applications, is the fact that majority of polymers have very poor thermal conductivity. The best ways to mitigate the disadvantage of low thermal conductivity, are to either supplement thermally conductive additives into the material or reduce the wall thickness of the material to a thermal resistance comparable to that of traditional metals.

With the advancement of AM techniques, polymer heat exchangers with novel intricate geometries that can potentially achieve high surface-to-volume ratios with thin wall thicknesses are now possible. Some methods of additive manufacturing include stereolithography, material jetting, sheet lamination, and fused filament fabrication (FFF). FFF requires first extruding polymers into a filament which are then fed into a 3D printer. Popular materials include ABS and PLA. There is a lot of interest in trying to print HDPE since filament can be easily made from recycled consumer containers. The feasibility of an encapsulation method of a SSPCM that can be used in FFF to produce a polymer heat exchanger for TES in reducing residential HVAC cooling loads is reviewed below.

### Implementation of PCM Polymer Heat Exchanger for Preconditioning

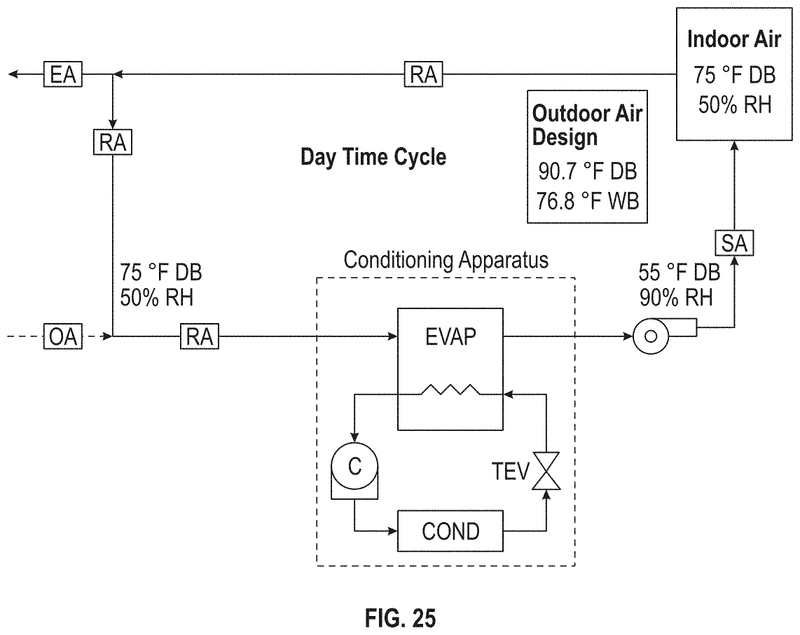

Residential HVAC systems for removing heat in most homes use the vapor compression cycle to condition air to a suitable human comfort level. FIG. 25 shows a schematic diagram of an example of a traditional HVAC system with a vapor compression cycle. Indoor design conditions can be dependent upon the regional location of the household and the given season. For the following discussions and future analysis, the indoor and outdoor design conditions chosen are based upon the location of Daytona Beach, Fla. (ASHRAE climate zone 2) with daytime summer season (cooling load). These conditions give an indoor design condition of 75° F. dry bulb temperature and 50% relative humidity. The outdoor design conditions are based upon the ASHRAE Handbook of Fundamentals 2017 for 1% cooling (ASHRAE 2017), which gives outdoor conditions of 90.7° F. and 76.8° F. dry bulb and wet bulb temperatures, respectively.

Standard vapor compression cycle systems for residential cooling are systems that can include two main flow paths, the return-air side and the supply-air side. Most residential systems recirculate a portion of the indoor air, commonly referred to as return air (RA), and send this air through the conditioning apparatus. A portion of the return air, or the indoor air itself, can be vented out of the residence and is considered exhaust air (EA). The RA is mixed with a portion of outside air (OA) and is sent through the conditioning apparatus to be conditioned to an approximate temperature and humidity that is supplied back to the room to keep the indoor conditions at the specified indoor settings. The conditioned air that is supplied to the room is referred to as supply air (SA). The SA is usually conditioned to a dry bulb temperature approximately 20° F. lower than the indoor design conditions. The cooling load on the system is usually based around the difference between the RA and SA temperatures and ambient conditions.

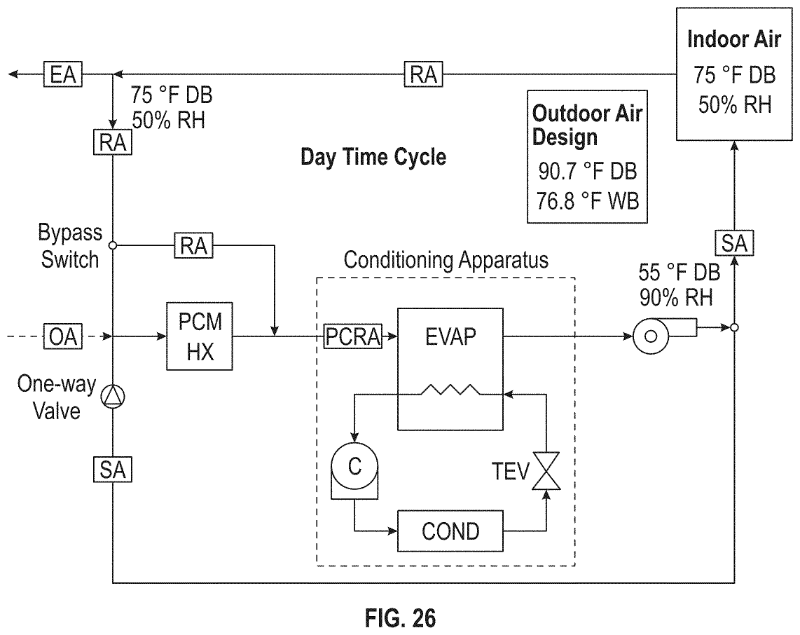

The cooling load on the system can be lowered by reducing the differences between the RA and SA temperatures. The SA temperature cannot usually be increased due to that temperature being necessary to keep the indoor space at the specified temperature. Therefore, the next possible way to reduce the cooling load is to lower the return air temperature before the conditioning apparatus. To utilize the concept of peak shaving during the daytime, a heat exchanger made at least in part of PCM can be used to passively precondition the return air (PCRA) temperature to a lower temperature. This PCM heat exchanger can be used in line to with the system to help reduce daytime cooling loads, which can be seen in FIG. 26 (showing a schematic diagram of a residential HVAC system with PCM heat exchanger for daytime preconditioning of return air).

The PCM heat exchanger can continually absorb heat and reduce the RA temperature, such as until the PCM has completely changed phase and is at a steady-state temperature equal to the return air temperature. The total time until the PCM reaches the RA temperature and no longer absorbs any heat is directly tied to the total mass of PCM within the heat exchanger. The selection of phase-change temperature can be dependent upon the target temperature. If the goal is to reduce the RA temperature to the SA temperature, then the target phase-change temperature can be set to the SA temperature, or a few degrees below. The reasoning behind having a target phase-change temperature a few degrees below the target temperature is due to majority of PCMs not changing phase at a single temperature. Therefore, the target phase-change temperature is generally chosen a few degrees below the SA temperature to ensure the entire phase change occurs before the temperature increases to above the SA temperature.

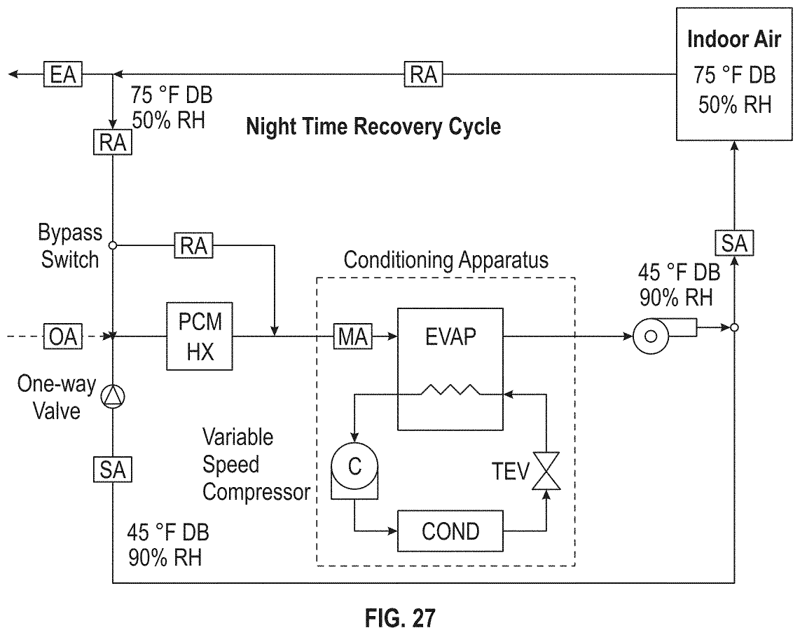

Once the PCM heat exchanger is at a steady-state temperature, the heat within the PCM can be released so the PCM can resolidify. This can occur during off-peak hours when electrical costs are relatively lower. The total energy saved during the day, by reducing the RA temperature, can be removed at night by the conditioning apparatus. To remove the heat within the heat exchanger, the RA can bypass the PCM heat exchanger and a portion of the SA should be supplied to the PCM remove the heat. With less mass flow rate of SA to the conditioned room, the SA temperature needs to be lower than during the day time. This can be achieved with a variable speed compressor in the conditioning apparatus. With the reduction in SA temperature, the portion of SA diverted to the PCM heat exchanger can help ensure that all of the necessary heat within the PCM is removed during the night. This configuration can be seen in FIG. 27, which shows a schematic diagram of residential HVAC system with PCM heat exchanger for night time energy recovery of energy storage capacity. Optionally, instead of cycling off after a cooling cycle, the fan and compressor can continue to run and divert the air to the PCM when cooing the space is not required, helping to increase efficiency by operating at a relatively higher refrigerant suction temperature. Use of SSPCM can allow print variations in thicknesses and can help to allow for optimized heat exchanger geometries which can help promote efficient heat transfer.

### Thermodynamic Modeling of Residential HVAC With Preconditioned Return Air

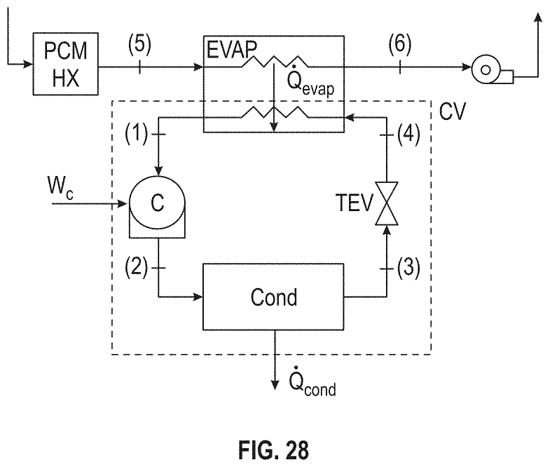

FIG. 28 shows a schematic diagram of control volume energy balance of vapor compression cycle with preconditioned return air. The work done by the conditioning apparatus to remove heat from the air supplied to the building is determined by the steady-state control volume energy balance shown in FIG. 28, where the work done by the system is primarily due to the work done by the compressor, Wc.

First, the mass flow rate of refrigerant in the cycle, \dot{m}_{R}, can be determined by the energy balance of the refrigerant side of the evaporator, given by:

\dot{Q}ₑᵥₐₚ=\dot{m}_{R}(h₁−h₄) Equation 1

\dot{Q}ₑᵥₐₚ can be the total capacity of the air conditioning units, h₁ can be the enthalpy of refrigerant after leaving the evaporator, and h₄ can be the enthalpy of refrigerant before entering the evaporator. An assumption of negligible pressure drop across the evaporator can be used. By determining the mass flow rate of refrigerant, the work done by the compressor, can be determined by an energy balance of the compressor:

W_{c}=\dot{m}_{R}(h₂−h₁) Equation 2

h₁ and h₂ can be the enthalpy before and after the compressor, respectively.

The mass flow rate of air supplied to the building, \dot{m}ₐ, can be determined by the energy balance, given by:

\dot{Q}ₑᵥₐₚ=\dot{m}ₐcₚΔT Equation 3

\dot{Q}ₑᵥₐₚ can be the heat removed from the air, which can be assumed to be equal to the amount of heat supplied to the refrigerant. The specific heat capacity of the air and the temperature difference of the air passing through the evaporator is cₚ and ΔT, respectively.

### Thermodynamic Properties

Given indoor and outdoor air design conditions as discussed above, outdoor air conditions are a dry bulb temperature of 90.7° F. and a wet bulb temperature of 76.8° F. The indoor air conditions for human thermal comfort are a dry bulb temperature of 75° F. and a relative humidity of 50%. The OA that enters the system to mix with the RA can be treated as ventilation and the RA can be approximated to have no change from the indoor air to the conditioning apparatus. Given the temperature and relative humidity of the air in the room, the RA will have an enthalpy, h₅, of 28.11 BTU/lbmda. This is also assumed to be the return air conditions from the room to the PCM heat exchanger and the conditioning apparatus. The air supplied to the indoor conditioned space to achieve the necessary temperature and relative humidity of the room is assumed to have a temperature and relative humidity of 55° F. and 90%, respectively. Given the temperature and relative humidity of the supply air, the enthalpy of the supply air, h, is 22.17 BTU/lbmda. The refrigerant used in the air conditioning unit is assumed to be R410A and the properties of the refrigerant is determined using the thermodynamic properties tables for DuPont SUVA 410A. This is a typical refrigerant used in residential HVAC applications. The air conditioning unit is modeled based upon a simple vapor compression cycle.

Assuming the refrigerant leaving the condenser has a negligible pressure drop and operates at a temperature 15° F. higher than the outdoor air conditions, giving that at state 3 the refrigerant is at a temperature, T₃, of 106° F. and is a saturated liquid. Knowing the refrigerant is a saturated liquid at 106° F., the pressure and enthalpy at state 3 can be determined from the saturation properties tables for R410A, which gives a pressure, P₃, and an enthalpy, h₃, of 359.22 psia and 55.1 BTU/lbm, respectively. The refrigerant leaving the evaporator is assumed to be a saturated vapor at a temperature, T₁, of 40° F. This gives a pressure, P₁=133.17 psia, an enthalpy, h₁=121.6 BTU/lbm, and an entropy, s₁=0.2484 BTU/lbm° R, from the saturated vapor property tables for R410A.

To understand the properties of the refrigerant at state 2, the compressor is first assumed to perform isentropic work. The pressure, P_2, is assumed to be equal to the pressure after the condenser, P_3, given negligible pressure drop across the condenser. For an isentropic process, the work is idealized as adiabatic and reversible. Therefore, the entropy is assumed equal to state 1, so s_2=s_1=0.2484 BTU/lbm° R. Understanding that with the given entropy (s_2) and pressure (P_2), the refrigerant is considered a superheated gas at this state and using a superheated property tables will give an isentropic enthalpy, h_2i, of 133.04 BTU/lbm. To find the actual enthalpy at state 2, an efficiency of 85% is assumed for the compressor. Given that efficiency for a compressor is:

$${η}_{c} = \frac{{W}_{i}}{{W}_{c}} = \frac{{h}_{1} - {h}_{2 i}}{{h}_{1} - {h}_{2 a}} \qquad Equation 4$$

N_{c} can be the efficiency of the compressor, Wᵢ can be the isentropic work for the compressor, W_{c} can be the actual work of the compressor, h₁ can be the enthalpy at state 1, h₂ᵢ can be the isentropic enthalpy at state 2, and h₂ₐ can be the actual enthalpy at state 2. Solving for h₂ₐ, the actual enthalpy at state 2 is 135.06 BTU/lbm.

Given a constant-enthalpy throttling process, which assumes no heat transfer or change in potential or kinetic energy through the expansion valve, the enthalpy after the thermal expansion valve can be assumed to remain constant to the enthalpy of state 3. Also, a negligible pressure drop is assumed across the evaporator, giving that the pressure at state 4 will be equal to the pressure at state 1.

### Thermodynamic Analysis Without Pre-Conditioning of Air

First, a thermodynamic analysis can be done for the work required to run the compressor without a PCM heat exchanger to precondition the air temperature before the evaporator unit.

Assuming a 1 ton system for a residential air conditioning unit, the mass flow rate of R410A refrigerant is determined by Equation 1 where \dot{Q}ₑᵥₐₚ is 12000 BTU/hr for a 1 ton system, h₁ can be the enthalpy 121.6 BTU/lbm at state 1, and h₄ can be the enthalpy 55.1 BTU/lbm at state 4. This can equate to a mass flow rate of refrigerant of 180.45 lbm/hr per ton.

By knowing the mass flow rate of refrigerant, the work of the compressor given no preconditioning of air temperature is determined by Equation 2, where \dot{m}_{R} can be the mass flow rate of refrigerant, as previously determined, h₂ can be the enthalpy 135.06 BTU/lbm at state 2, and h₁ is the enthalpy 121.6 BTU/lbm at state 1. The work of the compressor can equate to 711.2 W. This can be taken as the work done by the system to go from a non-preconditioned return air temperature of 75° F. to a typical supply air temperature of 55° F.

Lastly, the mass flow rate of supply air given no preconditioned return air temperature is determined by Eq. (3), where \dot{Q}ₑᵥₐₚ can be 12000 BTU/hr for a 1 ton system, \dot{m}ₐ can be the mass flow rate supply air per ton of refrigeration, cₚ is the specific heat capacity of air, and ΔT is the temperature difference of the return air into the evaporator by the supply air to the room. The mass flow rate of air given no preconditioning of air temperature can be 2500 lbm/hr·ton.

### Thermodynamic Analysis With Preconditioning of Air

With the addition of a PCM heat exchanger to precondition the return air temperature, the cooling load to lower the temperature can be reduced linearly proportional to the difference between the preconditioned air temperature and the required supply air temperature. This relationship can be seen fundamentally by Eq. (6), where the mass flow rate of the supply air, \dot{m}ₐ, and the specific heat capacity of the air, cₚ, can be held constant. Given a required supply air temperature of 55° F., the cooling load required to lower the preconditioned return air temperature at incremental intervals can be seen in Table 4.

TABLE 4
Compressor Work and Cooling Loads with Varying
Preconditioned Return Air Temperature

| T_{RA} | T_{SA} | m^{*}_a | Q^{*}_evap | m^{*}_R | W_{c} | W_{c} |
|---|---|---|---|---|---|---|
| (° F.) | (° F.) | (lbm/hr.ton) | (BTU/hr) | (lbm/hr) | (BTU/hr) | (W) |
| 75 | 55 | 2500 | 12000 | 180.5 | 2428.9 | 711.2 |
| 70 | 55 | 2500 | 9000 | 135.3 | 1821.7 | 533.4 |
| 65 | 55 | 2500 | 6000 | 90.2 | 1214.4 | 355.6 |
| 60 | 55 | 2500 | 3000 | 45.1 | 607.2 | 177.8 |
| 55 | 55 | 2500 | 0 | 0 | 0 | 0 |

### Conclusion

The results show the feasibility of implementing a TES device for residential and light commercial applications to reduce compressor work. PCMs that have phase-transition temperatures closer to the operating temperature of residential systems would can be used. Organic PCMs offer a unique opportunity, with the ability to be encapsulated in a novel manner that allows the PCM to be additively manufactured into a high surface-area-to-volume TES heat exchanger to store excess heat from the indoor air. The overall energy savings for the entire day is not necessarily reduced by this method, but overall energy cost is reduced by moving the necessary work of the conditioning apparatus to off-peak hours of operation.

### NOTES AND EXAMPLES

The following, non-limiting examples, detail certain aspects of the present subject matter to solve the challenges and provide the benefits discussed herein, among others.

Example 1 is an air conditioning system for conditioning an airstream, the system comprising: a refrigeration system including a condenser, a compressor, and an evaporator located at least partially in the airstream and configured to cool the airstream during operation of a cooling mode of the air conditioning system; a supply fan operable to produce the airstream; and a thermal energy storage heat exchanger located at least partially within in the airstream, the thermal energy storage heat exchanger comprising: a core made of a composite of a phase change material and a polymer such that the phase change material is configured to interact with the airstream to store energy from, and deliver energy to, the airstream.

In Example 2, the subject matter of Example 1 optionally includes wherein the thermal energy storage heat exchanger is located downstream of the evaporator and the supply fan.

In Example 3, the subject matter of any one or more of Examples 1-2 optionally include a heater configured to heat the airstream during operation of a heating mode of the air conditioning system, the heater located upstream of the thermal energy storage heat exchanger.

In Example 4, the subject matter of any one or more of Examples 1-3 optionally include wherein the composite of the core is made of at least twenty-five percent phase change material by mass.

In Example 5, the subject matter of Example 4 optionally includes wherein the composite of the core is made of less than seventy-five percent high density polyethylene.

In Example 6, the subject matter of any one or more of Examples 1-5 optionally include wherein core includes a first layer and a second layer, the first layer made of a first composite including a first phase change material configured to change phases at a first temperature and the second layer including a second phase change material configured to change phases at a second temperature that is higher than the first temperature.

In Example 7, the subject matter of Example 6 optionally includes wherein the thermal energy storage heat exchanger is a cross flow heat exchanger.

In Example 8, the subject matter of any one or more of Examples 1-7 optionally include wherein the thermal energy storage heat exchanger is a gyroid heat exchanger.

In Example 9, the subject matter of any one or more of Examples 1-8 optionally include wherein the thermal energy storage heat exchanger is a microchannel heat exchanger.

In Example 10, the subject matter of any one or more of Examples 7-9 optionally include wherein the thermal energy storage heat exchanger is formed through an additive manufacturing process using a composite filament made of phase change material and thermoplastic.

Example 11 is a thermal energy storage heat exchanger comprising: a core defining a plurality of airflow passages to receive an airstream therethrough, the core made of a composite of a phase change material shape-stabilized by a polymer, the phase change material structurally supported by the polymer, and the phase change material configured to change phases to store energy from and deliver stored energy to the airstream when the airflow passes through the core.

In Example 12, the subject matter of Example 11 optionally includes wherein the composite of the core is made of at least twenty five percent phase change material by mass.

In Example 13, the subject matter of Example 12 optionally includes wherein the composite of the core is made of less than seventy five percent high density polyethylene by mass.

In Example 14, the subject matter of any one or more of Examples 11-13 optionally include wherein the composite of the core is made of less than fifty percent high density polyethylene by mass and more than fifty percent phase change material by mass.

In Example 15, the subject matter of any one or more of Examples 11-14 optionally include wherein the core is manufactured through fused filament fabrication.

In Example 16, the subject matter of any one or more of Examples 11-15 optionally include wherein the core includes a first layer and a second layer, the first layer made of a first composite including a first phase change material configured to change phases at a first temperature and the second layer made of a second composite including a second phase change material configured to change phases at a second temperature that is higher than the first temperature.

Example 17 is a method of manufacturing a heat exchanger, the method comprising: melting and mixing a phase change material and a polymer; forming sheets of the mixed phase change material and the polymer; shredding the sheets of the phase change material and the polymer to form shredded portions; extruding the shredded portions of the phase change material and the polymer to form a composite filament; feeding the composite filament into a fused filament fabrication printer; and printing the heat exchanger used the fused filament fabrication printer.

In Example 18, the subject matter of Example 17 optionally includes heating the shredded portions prior to extruding.

In Example 19, the subject matter of any one or more of Examples 17-18 optionally include heating a chamber surrounding the fused filament fabrication printer before printing the heat exchanger.

In Example 20, the subject matter of any one or more of Examples 17-19 optionally include screening the filament for consistency prior to feeding the filament into the fused filament fabrication printer.

In Example 21, the subject matter of any one or more of Examples 17-20 optionally include wherein the polymer is high density polyethylene and the phase change material is organic phase change material.

In Example 22, the subject matter of Example 21 optionally includes wherein the heat exchanger is printed onto a high-density polyethylene build plate.

In Example 23, the subject matter of Example 22 optionally includes separating the heat exchanger from the high-density polyethylene build plate.

Example 24 is a coextruded material comprising a thermoplastic polymer and a phase-change material as shown and described herein.

Example 25 is a heat exchange as shown and described herein.

Example 26 is a method for fabricating a heat exchanger as shown and described herein.

Example 27 is a system for conditioning an airstream as shown and described herein.

Example 28 is a thermal energy storage method as shown and described herein.

In Example 29, the apparatuses or method of any one or any combination of Examples 1-28 can optionally be configured such that all elements or options recited are available to use or select from.

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

1. An air conditioning system for conditioning an airstream, the system comprising:
a refrigeration system including a condenser, a compressor, and an evaporator, the evaporator located at least partially in the airstream and configured to cool the airstream during operation of a cooling mode of the air conditioning system;
a supply fan operable to produce the airstream; and
a thermal energy storage heat exchanger located at least partially within in the airstream, the thermal energy storage heat exchanger comprising:
a core made of a composite of a phase change material and a polymer such that the phase change material is configured to interact with the airstream to store energy from, and deliver energy to, the airstream.

2. The air conditioning system of claim 1, wherein the thermal energy storage heat exchanger is located downstream of the evaporator and the supply fan.

3. The air conditioning system of claim 1, further comprising:
a heater configured to heat the airstream during operation of a heating mode of the air conditioning system, the heater located upstream of the thermal energy storage heat exchanger.

4. The air conditioning system of claim 1, wherein the composite of the core is made of at least twenty-five percent phase change material by mass.

5. The air conditioning system of claim 4, wherein the composite of the core is made of less than seventy five percent high density polyethylene.

6. The air conditioning system of claim 1, wherein core includes a first layer and a second layer, the first layer made of a first composite including a first phase change material configured to change phases at a first temperature and the second layer including a second phase change material configured to change phases at a second temperature that is higher than the first temperature.

7. The air conditioning system of claim 6, wherein the thermal energy storage heat exchanger is a cross flow heat exchanger.

8. The air conditioning system of claim 1, wherein the thermal energy storage heat exchanger is a gyroid heat exchanger.

9. The air conditioning system of claim 1, wherein the thermal energy storage heat exchanger is a microchannel heat exchanger.

10. The air conditioning system of claim 7, wherein the thermal energy storage heat exchanger is formed through an additive manufacturing process using a composite filament made of phase change material and thermoplastic.

11. A thermal energy storage heat exchanger comprising:
a core defining a plurality of airflow passages to receive an airstream therethrough, the core made of a composite of a phase change material shape-stabilized by a polymer, the phase change material structurally supported by the polymer, and the phase change material configured to change phases to store energy from and deliver stored energy to the airstream when the airflow passes through the core.

12. The thermal energy storage heat exchanger of claim 11, wherein the composite of the core is made of at least twenty five percent phase change material by mass.

13. The thermal energy storage heat exchanger of claim 12, wherein the composite of the core is made of less than seventy five percent high density polyethylene by mass.

14. The thermal energy storage heat exchanger of claim 11, wherein the composite of the core is made of less than fifty percent high density polyethylene by mass and more than fifty percent phase change material by mass.

15. The thermal energy storage heat exchanger of claim 11, wherein the core is manufactured through fused filament fabrication.

16. The thermal energy storage heat exchanger of claim 11, wherein the core includes a first layer and a second layer, the first layer made of a first composite including a first phase change material configured to change phases at a first temperature and the second layer made of a second composite including a second phase change material configured to change phases at a second temperature that is higher than the first temperature.

17. A method of manufacturing a heat exchanger, the method comprising:
melting and mixing a phase change material and a polymer;
forming sheets of the mixed phase change material and the polymer;
shredding the sheets of the phase change material and the polymer to form shredded portions;
extruding the shredded portions of the phase change material and the polymer to form a composite filament; and
printing the heat exchanger using a fused filament fabrication printer.

18. The method of claim 17, further comprising:
heating the shredded portions prior to extruding.

19. The method of claim 17, further comprising:
heating a chamber surrounding the fused filament fabrication printer before printing the heat exchanger.

20. The method of claim 17, wherein the polymer is high density polyethylene and the phase change material is organic phase change material.
